(19) United States
(12) Patent Application Publication
(10) Pub. No.: US 2012/0095735 A1
(43) Pub. Date: Apr. 19, 2012

(54) Method of Integration of Molecular Pathway Models

(76) Inventor: V. A. Shiva AYYADURAI, Belmont, MA (US)

(21) Appl. No.: 13/271,319

(22) Filed: Oct. 12, 2011

Related U.S. Application Data
(60) Provisional application No. 61/392,582, filed on Oct. 13, 2010.

(51) Int. Cl. G06F 7/60

(52) U.S. Cl. 703/2

(57) ABSTRACT

A method for integrating molecular pathway models provides a computational architecture to integrate multiple molecular pathway models. The present invention utilizes a number of systems for communicating mathematical models between servers to a main database for the derivation of an integral solution. The present invention provides a method for the creation of a complex model such as a whole cell.

The current application claims a priority to the U.S. Provisional Patent application Ser. No. 61/392,582 filed on Oct. 13, 2010.

### FIELD OF THE INVENTION

The present invention relates generally to a method for integrating molecular pathways models with minimal to no manual intervention.

### BACKGROUND OF THE INVENTION

The present invention is in the field of biology. More particularly, the present invention is in the technical field of computational systems biology. A grand challenge of computational systems biology is to build a large-scale molecular pathway model of the whole cell. Many molecular pathway models have been created with the advent of computers over the past several years. Conventional methods for integrating molecular pathway models are manual and cannot scale to integrate large number of models. Current approaches involve manually merging smaller molecular pathway models to create a large monolithic model that runs on a single computer. It is difficult to integrate these models for many reasons including: each model may have been created by individual teams; each located in different parts of the world; each designed to execute on a particular computer hardware systems; each model written in different formats; each model requires specific knowledge to understand; each model executes on different length and time scales; and, some models may not give direct access to the source codes. It is also difficult, if not impossible, to maintain a given integrated mode since ongoing updates to the source codes of the smaller models are constantly underway. Moreover, parameters for any one model may also be changing due to new experimental discoveries. Computational systems biology is seeking to find ways to integrate large numbers of smaller mathematical models to build larger-scale models as well as ways to easily maintain the resultant larger model. The current approaches involve a great degree of manual intervention and cannot scale to allow the development and maintenance of large-scale models.

### BRIEF DESCRIPTION OF THE DRAWINGS

FIG. 1 is a drawing of a molecular pathway model.

FIG. 2 is high-level drawing of molecular pathways, molecular pathway models and the integrator.

FIG. 3 is a drawing of the Integrator's architecture.

FIG. 4 is a flow chart diagram illustrating the process of deriving an integral solution using the present invention.

### DETAIL DESCRIPTIONS OF THE INVENTION

All illustrations of the drawings are for the purpose of describing selected versions of the present invention and are not intended to limit the scope of the present invention.

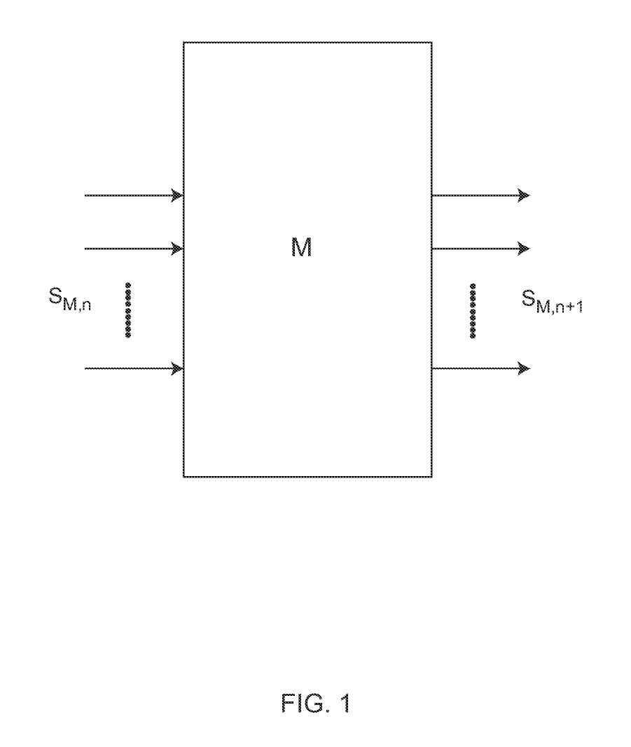

The invention herein provides a method to integrate molecular pathway models. This invention treats each molecular pathway model M, as shown in FIG. 1 as a system which has inputs and outputs, represented by the arrows to the left of the box, in the center, and the arrows to the right of the box, respectively, coming to and from the internals of the model M, illustrated as a box in the center. The internals of the model contain mathematical codes, which represent the chemical interactions of species, and convert the input to the output. At each time step the box in the center receives the inputs of the concentration of species at time step denoted as n, illustrated in FIG. 1 as S_{M,n}. The box, or model, in the center, executes computations to produce outputs which are the species concentrations for the next time step, denoted as time step n+1 illustrated in FIG. 1 as S_{M,n+1}.

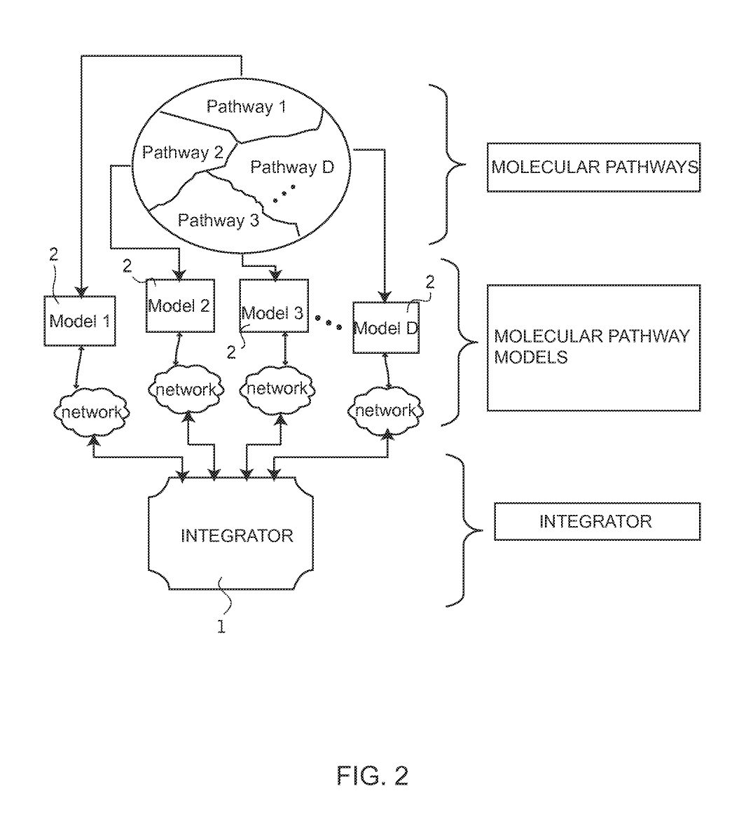

As shown on the top part of FIG. 2, the invention treats a cell, as defined by the ellipse on top of FIG. 2, as a container of D molecular pathways. In the middle of FIG. 2, the association of each of the plurality of molecular pathway to each of the plurality of models 2 numbered from 1 to D, which may exist and be accessible via any type of computer network. In the bottom of FIG. 2 is the method's Integrator 1, which communicates with each molecular pathway model 2 to integrate the models.

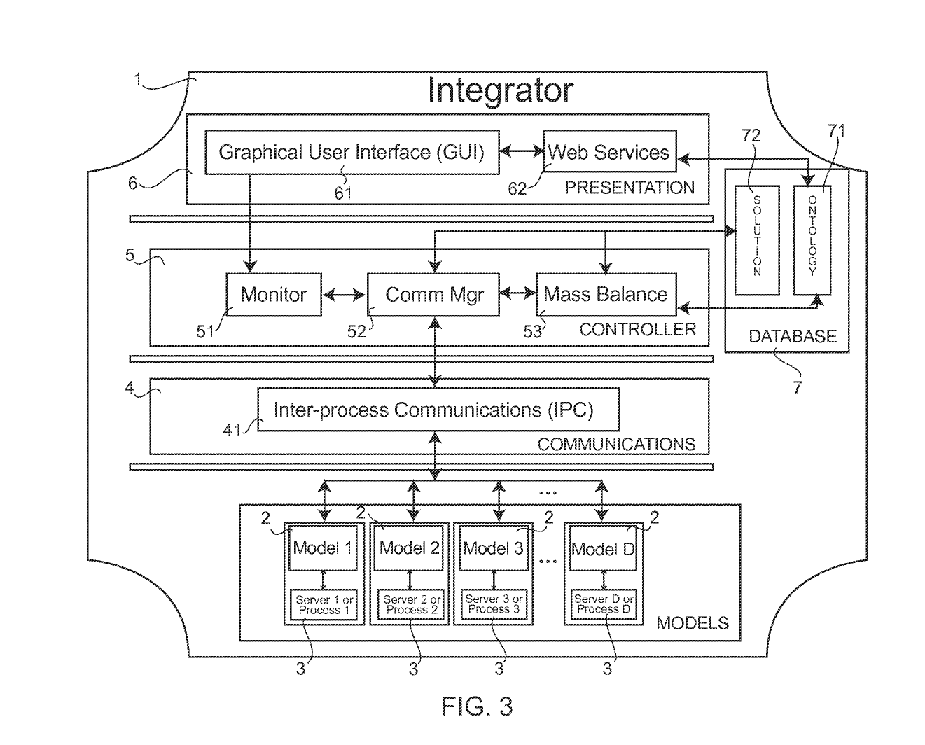

FIG. 3 shows the architecture of the method's integrator 1. This architecture consists of the following layers: Presentation 6, Controller 5, Communications 4, Models 2 and database 7. The presentation layer 6 includes a Graphical User Interface (GUI) 61 and web services 62. The user interacts with the GUI 61 to specify one or more molecular pathway models 2 to be integrated. A set of molecular pathway models 2 may have common species and/or duplicate reaction pathways. For the former case, e.g. two models 2 may refer to species Calcium but one may have refer it as If “Ca++” and another as “Cal”, a web service 62 is provided, which parses the models 2 and detects potential naming conflicts and allows the user through the GUI 61 to confirm or reject identical species. The web services 62 also provide the user a mechanism to identify common reaction pathways to enable alignment across models 2. All user-defined changes or such annotations to the models 2 to resolve species differences and reaction duplications are stored and updated within the ontology 71 of the database 7, for later use by the controller 5, during model integration. Once the user has specified models 2 and resolved conflicts, the controller 5 via the monitor 51, is invoked for executing model integration.

The controller 5 coordinates individual computations and couples models 2 to derive the integrated solution 72. The controller 5 includes libraries that support direct model-to-model messaging as well as model-to-controller messaging. The controller 5 has three components: the monitor 51, the communications manager 52, and the Mass balance 53. The monitor 51 serves to track the progress of each model's computation. The monitor 51 knows, for a particular time step, which models 2 have completed and which models 2 have not completed their calculation. The communications manager 52 coordinates the communication across all models 2. The communications manager 52 initiates a model to compute a time step of calculation and also can instruct a model to wait or hold on computing the next time step. The mass balance 53 integrates, for each time step, the calculations across an ensemble of models 2 by ensuring mass conservation of species, to derive the integrated solution 72.

The communications layer 4 contains the Inter-process Communications (IPC) infrastructure 41. The IPC 41 allows communication of user parameters (e.g. which models 2 to run) and results between the controller 5 and the Models 2. IPC 41 allows the controller 5 to perform dynamic messaging using two important operations. First, the controller 5 may message a model with input values of species concentrations at time step n, S_{M,n} and request the model to execute one time step of calculation. Second, a model 2, following execution of one time step of calculation, can message the controller 5 to send the output values of species concentrations at time step n+1, S_{M,n+1}. These operations enable the controller 5 to manage and steer the individual computations across multiple models 2 in parallel.

The database 7 layer consists of storage of the solution 72 and the ontology 71. The solution 72 holds memory resident data to track species concentrations across all models 2 for each time step. The ontology 71 manages nomenclature, the annotations of species identification, and any duplicate reaction pathways, across the plurality of models 2 to ensure consistency during the controller's 5 computation of the integrated solution 72. The ontology 71 can be evolved to support more complex descriptions.

The models layer denotes the set of models 2 to be integrated. These models 2 may each reside on a plurality of different servers 3, remote to the GUI 61. Or, the models 2 may reside on a single server 3, possibly the same server 3 as the GUI 61 but may run as individual processes. The invention treats each model as a module whose model code can be as simple or as complex as possible.

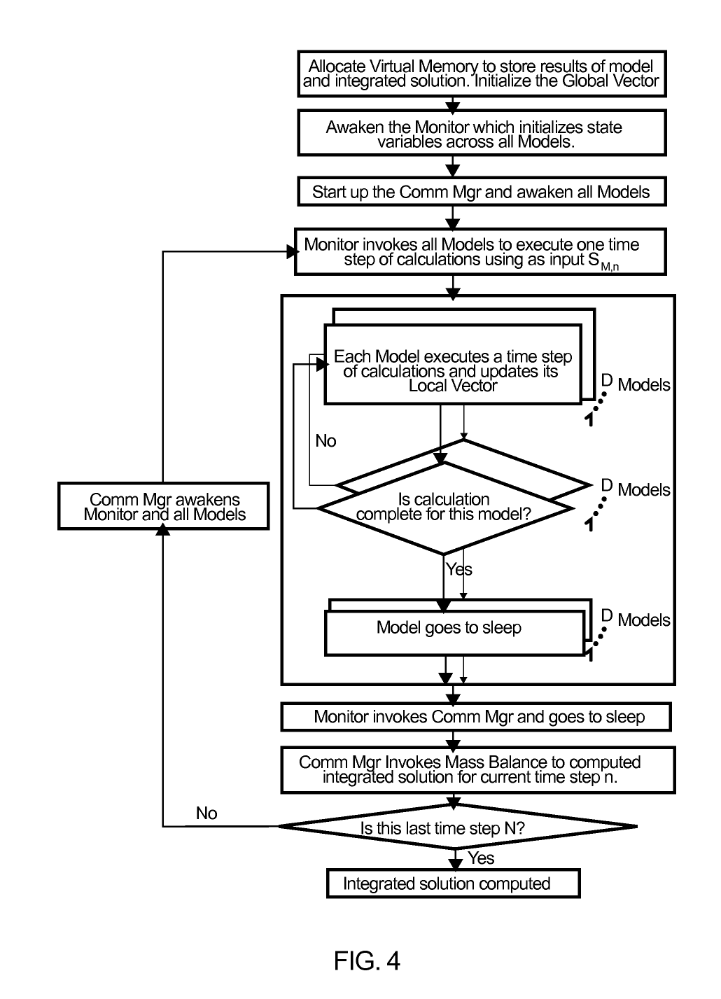

In reference to FIG. 4, the present invention initializes the solution process by awakening all of the models 2. Each of the plurality of models 2 is set in a standby status ready to perform its necessary calculations when called upon. The monitor 51 calls upon the necessary models 2 to execute one time step of the calculations using the inputs S_{M,n}. Each model 2 executes their time step of calculations until they are completed. Once a model 2 completes its needed calculations, it is put to sleep. The models 2 are executed when called upon by the monitor 51. Once each model 2 provides their necessary calculations, the monitor 51 invokes the communication manager 52 and goes to sleep. The communication manager 52 then invokes the mass balance 53 to compute the integral solution for the time step n. The present invention then determines whether or not the final time step has been taken. If not, the communication manager 52 awakens the monitor 51 and all of the models 2 to repeat the calculation process. The calculation process is cycled until each time step is calculated. Once the final time step has been calculated, the integral solution is computed and displayed for the user.

The method integrates the computations of multiple molecular pathway models 2 and eliminates to need to: 1) merge source codes and 2) centrally maintain and update the source codes of each model. There are a number of characteristics that this invention exhibits:

(1) Is scalable. Scalable or scalability means the effort to integrate a new model is comparable to the effort to integrate the first model.

(2) Support for both public and proprietary models. Public models have accessible source codes. Proprietary models have inaccessible source codes. A pharmaceutical company, for example, with proprietary models may seek to integrate with public models, and researchers in an academic environment, alternatively, may seek to integrate their public models with proprietary models.

(3) Support for multiple source code formats. It is not required to convert models to one common standard format. A model can remain resident its native format, thereby reducing time in source code rewriting and testing.

(4) Decentralized control. This means that users at all locations can initiate integration from their own local environment. Consider the scenario of the author of a Model A, who wishes to quickly test or integrate with an ensemble of three other models: Model B, C and D which are distributed across different machines. The author of Model A need not have to download the other three models to his/her local computer to perform the integration.

Although the invention has been explained in relation to its preferred embodiment, it is to be understood that many other possible modifications and variations can be made without departing from the spirit and scope of the invention as hereinafter claimed.

What is claimed is:

1. A method for integrating molecular pathway models by executing computer executable instructions stored on a non-transitory computer-readable medium, the method comprises the steps of:
(1) prompting and receiving a plurality of models for integration by means of a graphical user interface;
(2) parsing the plurality of models, wherein the plurality of models is mathematical codes calculated on a plurality of servers;
(3) detecting conflicts between each of the models of the plurality of models;
(4) resolving of the conflicts, wherein the conflicts are resolved by prompting the user or resolved automatically;
(5) communicating input and output parameters between the plurality of models;
(6) coupling individual computations of the plurality of models retrieved from the plurality of servers; and
(7) deriving of an integral solution over the plurality of models.

2. The method for integrating molecular pathway models by executing computer executable instructions stored on a non-transitory computer-readable medium, as claimed in claim 1 comprises:
tracking of derivation processes for the plurality of models by sending and dynamically integrating the inputs to the plurality of models through communication integration.

3. The method for integrating molecular pathway models by executing computer executable instructions stored on a non-transitory computer-readable medium, as claimed in claim 1 comprises:
instructing, by a communication manager, the plurality of models to initiate or hold calculation processes depending on the time step, wherein certain models require a solution from other models to proceed with calculation.

4. The method for integrating molecular pathway models by executing computer executable instructions stored on a non-transitory computer-readable medium, as claimed in claim 1 comprises:
wherein the derivation of the integral solution is calculated by a mass balance.

5. A method for integrating molecular pathway models by executing computer executable instructions stored on a non-transitory computer-readable medium, the method comprises the steps of:
(1) prompting and receiving a plurality of models for integration by means of a graphical user interface;
(2) parsing the plurality of models, wherein the plurality of models is mathematical codes calculated on a plurality of servers;
(3) detecting conflicts between each of the models of the plurality of models, wherein the conflicts are discrepancies between the plurality of models selected from the group consisting parameter naming inconsistencies, source code language format differences, logical conflicts, or different naming mechanisms for a common species between separate models;
(4) resolving of the conflicts, wherein the conflicts are resolved by prompting the user or resolved automatically;
(5) identifying and aligning of input parameters and output parameters across the plurality of models;
(6) communicating and transacting input and output across the plurality of models;
(7) coupling, by a controller, individual computations of the plurality of models retrieved from the plurality of servers; and
(8) deriving and displaying of an integral solution over the plurality of models, wherein the derivation of the integral solution is calculated by a mass balance.

6. The method for integrating molecular pathway models by executing computer executable instructions stored on a non-transitory computer-readable medium, as claimed in claim 5 comprises:
tracking of derivation processes for the plurality of models by sending and dynamically integrating the inputs to the plurality of models through communication integration, wherein the monitor is able to determine whether or not a derivation process is complete; and
instructing, by a communication manager, the plurality of models to initiate or hold calculation process depending on the time step, wherein certain models require a solution from other models to proceed with calculation.

7. A method for integrating molecular pathway models by executing computer executable instructions stored on a non-transitory computer-readable medium, the method comprises the steps of:
(1) prompting and receiving a plurality of models for integration by means of a graphical user interface;
(2) parsing the plurality of models, wherein the plurality of models is mathematical codes calculated on a plurality of servers;
(3) detecting conflicts between each of the models of the plurality of models, wherein the conflicts are discrepancies between the plurality of models selected from the group consisting parameter naming inconsistencies, source code language format differences, logical conflicts, or different naming mechanisms for a common species between separate models;
(4) resolving of the conflicts, wherein the conflicts are resolved by prompting the user or resolved automatically;
(5) storing of the conflict resolutions into a ontology of a database;
(6) identifying and aligning of input parameters and output parameters across the plurality of models;
(7) communicating and transacting input and output across the plurality of models;
(8) coupling, by a controller, individual computations of the plurality of models retrieved from the plurality of servers;
(9) deriving and displaying of an integral solution over the plurality of models, wherein the derivation of the integral solution is calculated by a mass balance; and
(10) storing of the integral solution into a solution of the database, wherein the database further holds memory resident data to track input/output values across the plurality of models for each time step.

8. The method for integrating molecular pathway models by executing computer executable instructions stored on a non-transitory computer-readable medium, as claimed in claim 7 comprises:
tracking of derivation processes for the plurality of models by sending and dynamically integrating the inputs to the plurality of models through communication integration, wherein the monitor is able to determine whether or not a derivation process is complete; and
instructing, by a communication manager, the plurality of models to initiate or hold calculation processes depending on the time step, wherein certain models require a solution from other models to proceed with calculation.
